(19) United States
(12) Patent Application Publication
(10) Pub. No.: US 2025/0360898 A1
(43) Pub. Date: Nov. 27, 2025

(54) METHOD FOR OPERATING A POWER BRAKE SYSTEM, POWER BRAKE SYSTEM, AND A MOTOR VEHICLE

(71) Applicant: Robert Bosch GmbH, Stuttgart (DE)

(72) Inventors: Gerd Frick, Abstatt (DE); Markus Bartel, Untergruppenbach (DE); Peter Ziegler, Grossbottwar (DE); Christian Frank, Ludwigsburg (DE)

(21) Appl. No.: 19/211,991

(22) Filed: May 19, 2025

(30) Foreign Application Priority Data
May 24, 2024 (DE) 10 2024 204 790.2

(51) Int. Cl. B60T 8/172; B60T 7/12; B60T 8/171

(52) U.S. Cl. CPC B60T 8/172; B60T 7/12; B60T 8/171; B60T 2220/04; B60T 2270/402; B60T 2270/406

(57) ABSTRACT

A method for operating a power brake system, which includes a braking device to which a primary and a secondary actuation device for generating a hydraulic brake pressure are assigned, which are designed to receive a braking request signal that is representative of a braking request by electronics. The method includes: collecting information on the functionality of the primary actuation device by the secondary actuation device in a first collection mode using electronic communication between the primary and the secondary actuation device and collecting the information on the functionality of the primary actuation device in a second collection mode by ascertaining a hydraulic brake pressure generated by the primary actuation device by the secondary actuation device if no information on the functionality of the primary actuation device can be collected by the secondary actuation device in the first collection mode.

### FIELD

The present invention relates to a method for operating a power brake system, to a power brake system and to a motor vehicle having such a power brake system.

### BACKGROUND INFORMATION

Certain methods for operating a power brake system in motor vehicles are described in the related art, wherein the power brake system comprises a braking device to which a primary actuation device and a secondary actuation device for generating a hydraulic brake pressure are assigned. The secondary actuation device serves as a fallback level in the event of a disruption in the primary actuation device. The braking device can be actuated by the primary actuation device during normal operation, wherein a check of the availability of the fallback level in the form of the secondary actuation device is performed at specified time intervals during normal operation of the power brake system.

German Patent Application No. DE 10 2020 210 598 A1 describes a conventional example of a method for operating a power brake system in motor vehicles.

Europe Patent No. EP 0 961 724 B1 relates to a braking system for a motor vehicle and to a method for transmitting data in an electrically controlled motor vehicle braking system.

Germany Patent Application No. DE 199 04 721 A1 describes a braking system for a motor vehicle.

Germany Patent Application No. DE 10 2018 222 313 A1 describes a braking system in an at least partially autonomous vehicle.

### SUMMARY

The present invention ensures particularly safe automatic braking of the motor vehicle in the event of a disruption of the power brake system; in particular, it is ensured that no unnecessary or unwanted braking of the motor vehicle will occur by a secondary actuation device in a disruption mode as long as the primary actuation device provided for actuating the braking device continues to be functional. In particular, the present invention achieves increased insensitivity of the power brake system to disruptions in electronic communication.

According to the present invention, among other things, a method for operating a power brake system, along with a power brake system, and a motor vehicle are provided.

According to an example embodiment of the present invention, a method for operating a power brake system is provided, wherein the power brake system to be operated comprises a braking device to which a primary and a secondary actuation device for generating a hydraulic brake pressure are assigned, which are designed to receive a braking request signal that is representative of a braking request by electronic means. In the method, information on the functionality of the primary actuation device is collected by the secondary actuation device in a first collection mode using electronic communication between the primary and the secondary actuation device. The corresponding information can, for example, be transmitted by the primary actuation device and/or queried by the secondary actuation device. The information is preferably collected permanently or regularly, if necessary at certain intervals. If no information on the functionality of the primary actuation device can be collected by the secondary actuation device using electronic communication, i.e. in the first collection mode, because, for example, the electronic communication itself is disrupted, the system reverts to a second collection mode. In this case, the information on the functionality of the primary actuation device is collected in the second collection mode by ascertaining a hydraulic brake pressure generated by the primary actuation device by the secondary actuation device if no information on the functionality of the primary actuation device can be collected by the secondary actuation device in the first collection mode. This can preferably be carried out by a pressure sensor in the hydraulic brake circuit assigned to the secondary actuation device.

Furthermore, according to an example embodiment of the present invention, a power brake system for performing the method according to the present invention and a motor vehicle having such a power brake system are provided, wherein the motor vehicle is preferably designed for highly automated or autonomous driving, particularly preferably having an automation degree or SAE level of 4 or 5.

One idea of the present invention lies in continued secure communication between the primary and the secondary actuation device in a second collection mode, even if the first collection mode should be lost due to a disruption of the electronic communication between the two actuation devices. Thus, a disruption of electronic communication alone is not an indication of a non-functionality of the primary actuation device; rather, the functionality of the primary actuation device can continue to be detected in the second collection mode, before the second actuation device initiates any necessary emergency measures, such as automatic braking of the motor vehicle. By allowing the secondary actuation device to revert to a measurement of the hydraulic activity of the primary actuation device in the event of a disruption of the electronic communication in the second collection mode, a secure hydraulic communication channel is correspondingly created that is insensitive to any electronic disruption, such as a cyber attack.

Advantageous embodiments and developments of the present invention can be found in the disclosure herein.

In a preferred embodiment of the method according to the present invention, it is ascertained whether the secondary actuation device can receive a braking request signal and is functional. This ascertainment is preferably carried out by the secondary actuation device itself, which therefore performs a self-monitoring. If it is ascertained that the secondary actuation device cannot receive a braking request signal by electronic means, for example because there is a disruption in the transmission, but the secondary actuation device is functional and can therefore build up a brake pressure, the braking device is put into a disruption mode. In the disruption mode, the braking device is automatically actuated in the sense of emergency braking by the secondary actuation device if no hydraulic activity of the primary actuation device is ascertained by the secondary actuation device in the second collection mode for a predetermined time period.

In a further preferred embodiment of the method according to the present invention, information on the functionality of the secondary actuation device is collected by the primary actuation device. This is preferably carried out using electronic communication between the secondary and the primary actuation device. If no information on the functionality of the secondary actuation device can be collected by the primary actuation device, a hydraulic brake pressure is generated by the primary actuation device at time intervals, wherein the time intervals in each case are shorter than the predetermined time period. In this way, the secondary actuation device can determine hydraulic activity of the primary actuation device and thus its functionality in the second collection mode even if the primary actuation device does not receive a braking request signal, meaning that no braking request is currently present. Thus, in the disruption mode of the braking device, unnecessary braking by the secondary actuation device in the sense of emergency braking is avoided. However, if the primary actuation device is not functioning, it cannot generate a brake pressure and the secondary actuation device brakes the motor vehicle for safety reasons.

In a further preferred embodiment of the method according to the present invention, a mode of the braking device is detected by the primary actuation device, wherein this is preferably carried out using electronic communication, particularly preferably between the primary and the secondary actuation device. If the disruption mode is detected, a hydraulic brake pressure is generated by the primary actuation device at time intervals that in each case are shorter than the predetermined time period.

In a further preferred embodiment of the method according to the present invention, the aforementioned generation of the hydraulic brake pressure by the primary actuation device is performed either on the basis of an actually received braking request signal, producing a braking effect, or merely for the purpose of detecting a hydraulic activity by the secondary actuation device in the second collection mode. In the latter case, a significantly lower hydraulic brake pressure is preferably generated than when a braking request is present, which barely produces any braking effect and/or is generated only in pulses.

In a further preferred embodiment of the method according to the present invention, the braking device is automatically actuated by the secondary actuation device in the disruption mode if information on the functionality of the primary actuation device is collected by the secondary actuation device in the first collection mode, which information characterizes a non-functionality of the primary actuation device. In this embodiment, a disruption would therefore be detected in which the electronic communication is intact, there is actually a disruption on the part of the primary actuation device and the secondary actuation device is functional but cannot receive a brake signal, which makes emergency braking necessary by using the secondary actuation device.

In a further preferred embodiment of the method according to the present invention, the functionality of the primary actuation device is monitored and the associated information on the functionality of the primary actuation device is ascertained by the primary actuation device. This means that functionality is monitored automatically. If the information thus ascertained is characteristic of a non-functionality of the primary actuation device, the information on the functionality of the primary actuation device is preferably transmitted to the secondary actuation device using electronic communication between the primary and the secondary actuation device.

The present invention is explained in more detail below using exemplary embodiments with reference to the figures.

### BRIEF DESCRIPTION OF THE DRAWINGS

FIG. 1 is a schematic representation of an example embodiment of the power brake system according to the present invention in a motor vehicle.

FIG. 2 is a flow chart for illustrating an example embodiment of a method of the present invention for operating the power brake system according to FIG. 1.

### DETAILED DESCRIPTION OF EXAMPLE EMBODIMENTS

The accompanying figures are intended to impart further understanding of the embodiments of the present invention. They illustrate embodiments and, in connection with the description, serve to explain principles and concepts of the present invention. The elements of the figures are not necessarily shown to scale relative to one another.

In the figures, identical, functionally identical and identically acting elements, features and components are provided with the same reference signs in each case, unless otherwise stated.

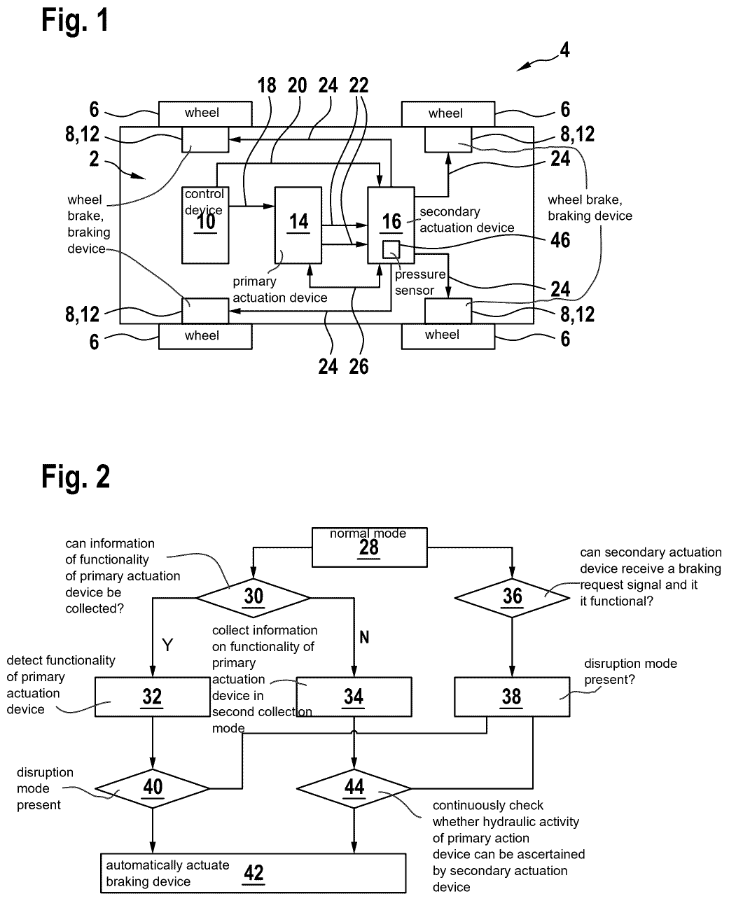

FIG. 1 is a schematic representation of an embodiment of the power brake system 2 according to the present invention in a motor vehicle 4.

The motor vehicle 4 comprises four wheels 6, which in each case are assigned a wheel brake 8. Although not shown, in each case two wheel brakes 8 of the total of four wheel brakes 8 can be assigned to one brake circuit. In addition to the wheel brakes 8, the power brake system 2 comprises a control device 10. In the case of a highly automated or even autonomous motor vehicle 4, the control device 10 can, for example, be a vehicle control computer. Alternatively, the control device 10 can also be designed as a brake pedal for interaction with a vehicle driver. The control device 10 is designed in such a way that, when a braking request is present, it transmits a braking request signal to the subsequent actuation devices by electronic means, which in turn are designed to receive the braking request signal that is representative of the braking request. The present case relates to a brake-by-wire arrangement or by-wire actuation.

The wheel brakes 8 together form a braking device 12 of the power brake system 2, wherein a primary actuation device 14 and a secondary actuation device 16 are assigned to the braking device 12. Both actuation devices 14, 16 serve to generate a hydraulic brake pressure for the wheel brakes 8 of the braking device 12. For example, the actuation devices 14, 16 can in each case comprise an electrical control unit and an electro-hydraulic device, wherein the latter is controlled by the electrical control unit. As already indicated above, both the electrical control unit of the actuation device 14 and the electrical control unit of the actuation device 16 can be acted upon by the braking request signal of the control device 10, as is indicated by the braking request signal 18 to the primary actuation device 14 and the braking request signal 20 to the secondary actuation device 16. The primary and the secondary actuation device 14, 16 are accordingly designed for receiving the braking request signal 18, 20.

The brake pressure generated or capable of being generated by the primary actuation device 14 passes via the secondary actuation device 16 to the wheel brakes 8 of the braking device 12, as schematically indicated by the hydraulic lines 22 and 24. In FIG. 1, the double arrow 26 indicates a communication path or a communication channel via which the primary actuation device 14 and the secondary actuation device 16 can communicate electronically with one another, wherein this communication path 26 can be, for example, a network or a signal line.

FIG. 2 is a flow chart for illustrating an embodiment of the method for operating the power brake system according to FIG. 1.

Method step 28 indicates a normal mode of the braking device 12. If necessary, the braking request signal 18 with a braking request is sent via the control device 10 to the primary actuation device 14, which can thereupon generate a corresponding hydraulic brake pressure and transmit it via the hydraulic lines 22, 24 to the wheel brakes 8 of the braking device 12, without the secondary actuation device 16 having to be used. Meanwhile, the functionality of the primary actuation device 14 is continuously monitored in order to ascertain, on the basis of the monitoring, information on the functionality of the primary actuation device 14 by the primary actuation device 14 itself. Thus, the functionality is automatically monitored by the primary actuation device 14.

In method step 30, it is checked whether information on the functionality of the primary actuation device 14 can be collected by the secondary actuation device 16 in a first collection mode using electronic communication 26 between the primary and the secondary actuation device 14, 16. If this is the case, the functionality of the primary actuation device 14 is detected by the secondary actuation device 16 in the first collection mode, i.e. via the electronic communication 26, as indicated in method step 32. If, however, no information on the functionality of the primary actuation device 14 can be collected by the secondary actuation device 16 in the first collection mode, information on the functionality of the primary actuation device 14 is collected in a second collection mode by ascertaining a hydraulic brake pressure generated by the primary actuation device 14 by the secondary actuation device 16, as indicated by method step 34.

In parallel to this, the secondary actuation device 16 automatically ascertains in method step 36 whether the secondary actuation device 16 can receive a braking request signal 20 and is functional. If the secondary actuation device 16 cannot receive a braking request signal 20 but is functional, the braking device 12 is put into a disruption mode, which is indicated by method step 38.

If the information on the functionality of the primary actuation device 14 is collected in method step 32 in the first collection mode, i.e. by electronic communication 26, then in method step 40 a check is carried out as to whether, on the one hand, the disruption mode 38 is present and, on the other hand, information on the functionality of the primary actuation device 14 is collected by the secondary actuation device 16 in the first collection mode, which information characterizes a non-functionality of the primary actuation device 14. If both are the case, the braking device 12 is automatically actuated by the secondary actuation device 16 in method step 42 in the sense of emergency braking.

If the information on the functionality of the primary actuation device 14 is collected in method step 34 in the second collection mode, i.e. by ascertaining a hydraulic brake pressure generated by the primary actuation device 14, further checks are preferably performed within the scope of method step 34.

Thus, information on the functionality of the secondary actuation device 16 can be collected by the primary actuation device 14, preferably using electronic communication 26 between the secondary and the primary actuation device 16, 14. If no information on the functionality of the secondary actuation device 16 can be collected by the primary actuation device 14, a hydraulic brake pressure is generated by the primary actuation device 14 at time intervals that are shorter than a predetermined time period. Alternatively or additionally, a mode of the braking device 12 is detected by the primary actuation device 14, preferably using electronic communication 26, particularly preferably between the primary and the secondary actuation device 14, 16. If the disruption mode 38 is detected, a hydraulic brake pressure is generated by the primary actuation device 14 at time intervals that are shorter than the predetermined time period.

In method step 44, it is continuously checked whether or not a hydraulic activity of the primary actuation device 14 can be ascertained by the secondary actuation device 16 in the second collection mode for the predetermined time period. For this purpose, the secondary actuation device 16 preferably comprises at least one pressure sensor 46 in order to detect a hydraulic brake pressure possibly generated by the primary actuation device 14 and thus a hydraulic activity of the primary actuation device 14. If no hydraulic activity is detected within the predetermined time period and the disruption mode 38 is present, in which the secondary actuation device 16 cannot receive a braking request signal 20, the braking device 12 is actuated by the secondary actuation device 16 in the sense of emergency braking in method step 42.

If, however, the electronic communication path 26 is disrupted while the primary actuation device 14 continues to be functional and is therefore able to generate a corresponding hydraulic brake pressure, this is detected by the pressure sensor 46 and the secondary actuation device 16 can remain inactive in view of the functioning primary actuation device 14 and, in particular, does not have to initiate emergency braking.

1-9. (canceled)

10. A method for operating a power brake system including a braking device to which a primary and secondary actuation device for generating a hydraulic brake pressure are assigned, the primary and second actuation devices configured to receive a braking request signal that is representative of a braking request by electronics, the method comprising the following steps:
collecting information on functionality of the primary actuation device by the secondary actuation device in a first collection mode using electronic communication between the primary and the secondary actuation device; and
collecting the information on the functionality of the primary actuation device in a second collection mode by ascertaining a hydraulic brake pressure generated by the primary actuation device by the secondary actuation device when no information on the functionality of the primary actuation device can be collected by the secondary actuation device in the first collection mode.

11. The method according to claim 10, further comprising the following steps:
ascertaining, by the secondary actuation device, whether the secondary actuation device can receive a braking request signal and is functional;
putting the braking device into a disruption mode when the secondary actuation device cannot receive a braking request signal but is functional; and
automatically actuating the braking device in the disruption mode by the secondary actuation device when no hydraulic activity of the primary actuation device is ascertained by the secondary actuation device in the second collection mode for a predetermined time period.

12. The method according to claim 11, further comprising the following steps:
collecting information on the functionality of the secondary actuation device by the primary actuation device, using electronic communication between the secondary and the primary actuation device; and
generating a hydraulic brake pressure by the primary actuation device at time intervals that are shorter than the predetermined time period when no information on the functionality of the secondary actuation device can be collected by the primary actuation device.

13. The method according to claim 11, further comprising the following steps:
detecting a mode of the braking device by the primary actuation device, using electronic communication between the primary actuation device and the secondary actuation device; and
generating a hydraulic brake pressure by the primary actuation device at time intervals that are shorter than the predetermined time period when the disruption mode is detected.

14. The method according to claim 12, wherein the hydraulic brake pressure is generated by the primary actuation device either: (i) based on a received braking request signal producing a braking effect, or (ii) for detecting a hydraulic activity by the secondary actuation device.

15. The method according to claim 11, further comprising the following step:
automatically actuating the braking device in the disruption mode by the secondary actuation device when information on the functionality of the primary actuation device is collected by the secondary actuation device in the first collection mode, the information characterizing a non-functionality of the primary actuation device.

16. The method according to claim 10, further comprising the following steps:
monitoring the functionality of the primary actuation device and ascertaining the information on the functionality of the primary actuation device by the primary actuation device;
wherein the information on the functionality of the primary actuation device is transmitted to the secondary actuation device using electronic communication between the primary and the secondary actuation device when the information on the functionality of the primary actuation device characterizes a non-functionality of the primary actuation device.

17. A power brake system for a motor vehicle, wherein the power brake system includes a braking device to which a primary and secondary actuation device for generating a hydraulic brake pressure are assigned, the primary and second actuation devices configured to receive a braking request signal that is representative of a braking request by electronics, the power brake system configured to:
collect information on functionality of the primary actuation device by the secondary actuation device in a first collection mode using electronic communication between the primary and the secondary actuation device; and
collect the information on the functionality of the primary actuation device in a second collection mode by ascertaining a hydraulic brake pressure generated by the primary actuation device by the secondary actuation device when no information on the functionality of the primary actuation device can be collected by the secondary actuation device in the first collection mode.

18. A motor vehicle, comprising:
a power brake system including a braking device to which a primary and secondary actuation device for generating a hydraulic brake pressure are assigned, the primary and second actuation devices configured to receive a braking request signal that is representative of a braking request by electronics, the power brake system configured to:
collect information on functionality of the primary actuation device by the secondary actuation device in a first collection mode using electronic communication between the primary and the secondary actuation device, and
collect the information on the functionality of the primary actuation device in a second collection mode by ascertaining a hydraulic brake pressure generated by the primary actuation device by the secondary actuation device when no information on the functionality of the primary actuation device can be collected by the secondary actuation device in the first collection mode;
wherein the motor vehicle is configured for highly automated or autonomous driving.
